(19) United States
(12) Patent Application Publication
(10) Pub. No.: US 2013/0124322 A1
(43) Pub. Date: May 16, 2013

(54) TARGETING INFORMATION TO A USER BASED ON VIEWED PROFILE PAGES

(71) Applicants: Brian Thomas Boland, Los Altos, CA (US); Gokul Rajaram, Los Altos, CA (US)

(72) Inventors: Brian Thomas Boland, Los Altos, CA (US); Gokul Rajaram, Los Altos, CA (US)

(21) Appl. No.: 13/297,180

(22) Filed: Nov. 15, 2011

(51) Int. Cl. G06Q 30/02

(52) U.S. Cl. 705/14.58; 705/14.66

(57) ABSTRACT

A social networking system maintains profile information about a subject user and about a viewing user. The viewing user requests a page of information about the subject user (e.g., a profile page) from the social networking system. The social networking system determines a set of interests or other information about the subject user based on the subject user's profile information. One or more ads are selected based at least in part on the set of determined interests or other information about the subject user. The profile page of the subject user is generated, where the profile page comprises profile information about the subject user along with the selected ads. The profile page of the subject user is then sent to the viewing user for display.

### BACKGROUND

This invention relates generally to social networking, and in particular to providing information items, including advertisements, to users of a social networking system.

Online advertising has evolved into a profitable business, allowing commercial and private entities alike to place advertisements on websites and within native applications, and then display the advertisements to viewing users who access the websites and applications. The ability to analyze data associated with a particular website, application, and/or the viewing user has allowed advertisers to provide ads that are more relevant to a viewing user's interests. More relevant ads increase the likelihood of ad conversion (e.g., that the viewing user will observe the ad, click on the ad, proceed to the advertiser's website, or otherwise respond to the ad with the intended result) and/or the likelihood of greater demand for or awareness of the advertiser's goods or services, thereby raising the effectiveness of the ad.

Ad targeting attempts to increase ad conversion rates by showing ads to a user that are relevant to the user's interests. Current ad systems present advertisements targeted to a user's interests regardless of the user's mindset. In particular, current ad systems fail to consider what a user is viewing when determining the user's interests.

### SUMMARY

To provide more relevant information items to a user of a social networking system, embodiments of the invention select information items for display to a viewing user based on a subject user's profile when the viewing user is viewing the subject user's profile page or other page that is associated with the subject user. In this way, the social networking system uses the viewing user's viewing of the subject user's profile page as a proxy for the viewing user's current interest in the subject user. Thus, displaying advertisements related to the interests or other profile information about the subject user increases the effectiveness of the advertisements or other information items targeted to the viewing user.

In one embodiment, a social networking system maintains profile information about a subject user and about a viewing user. The viewing user requests a profile page of the subject user from the social networking system, where the profile page has an area for displaying one or more ads to the viewing user. The social networking system determines a set of interests or other information about the subject user based on the subject user's profile information maintained in the social networking system. One or more ads are selected based at least in part on the set of determined interests or other information about the subject user. The profile page of the subject user is generated, where the profile page comprises profile information about the subject user along with the selected ads. The profile page of the subject user is sent to the viewing user for display.

By including ads that are relevant to the subject user in the profile page of the subject user, the ads are more likely to be relevant to the viewing user's current state of mind. In addition to increasing likely ad conversion rates, the more relevant ads also increase the user's overall enjoyment of the social networking system, since the ads are more likely to include useful information. For example, the ads may be social ads, which convey information about an action of the subject user that is related to the ad. Therefore, even the ads shown on the subject user's profile page may contain relevant social information about the subject user.

In other embodiments, the ads may be displayed on a profile page of a subject user to whom the viewing user is not connected to in the social networking system. In this case, an ad may be included on the profile page based on information about the subject user and/or information about another user who is connected to both the viewing user and the subject user (e.g., a common friend). In another embodiment, the ads may be displayed to the viewing user while viewing his or her own profile page. In this case, an ad may be selected for the viewing user's own profile page based on information about a subject user whose profile page the viewing user recently viewed or based on a subject user with whom the viewing user recently interacted. Finally, the ads may be shown on pages other than profile pages, such as pages displaying photo albums, games, videos, messages, or any other page of a social networking system. In these cases, the ads may be selected for the viewing user based on information about a subject user who is associated with something displayed on the page (e.g., tagged in a photo, displayed on a game leader board, included in a message thread, etc.).

In another embodiment, the social networking system determines how various subject users are likely to influence the viewing user. For example, one subject user may be knowledgeable about sports while another subject user is knowledgeable about cooking. The viewing user may then be more likely to be influenced by the two subject users more when the topic is about their expertise. The social networking system may measure the influence that a particular subject user has on the viewing user in a particular domain, for example, by observing click-through rates of social ads or other suggestions that are related to the subject user and the domain. When selecting an ad for a viewing user based on information about the subject user, the social networking system may use the information about how the subject user influences the viewing user to select the ads, e.g., by selecting an ad in a domain where the subject user has a relatively high influence on the viewing user.

### BRIEF DESCRIPTION OF THE DRAWINGS

FIG. 1 is a high level block diagram illustrating a system environment suitable for providing information items to a viewing user based on information about a subject user when the viewing user is viewing a page of information related to the subject user, in accordance with some embodiments.

FIG. 2 is a high level block diagram of a system for providing information items to a viewing user based on information about a subject user when the viewing user is viewing a page of information related to the subject user, in accordance with some embodiments.

FIG. 3 is a flow chart illustrating a process for providing information items to a viewing user based on information about a subject user when the viewing user is viewing a page of information related to the subject user, in accordance with some embodiments.

FIG. 4 is a flow chart illustrating a process for providing information items to a viewing user based on information about a subject user when the viewing user is viewing a page of information related to the subject user, in accordance with some embodiments.

FIG. 5 is a screenshot of a profile page, in accordance with some embodiments.

The figures depict various embodiments of the described methods and systems and are for purposes of illustration only. One skilled in the art will readily recognize from the following discussion that alternative embodiments of the methods and systems illustrated herein may be employed without departing from the principles of the methods and systems described herein.

### DETAILED DESCRIPTION

### Overview of Social Networking System

Online social networking systems comprise one or more computing devices storing a social network, or a social graph, comprising a plurality of users and providing users of the social networking system with the ability to communicate and interact with other users of the social networking system. Social networking systems allow users to explicitly associate themselves and establish connections with other users of the social networking system. When two users become connected, they are said to be “friends,” “contacts,” “connections,” or “associates” within the context of the social networking system. Alternatively, connections may be automatically created by the social networking system based on common characteristics of the users (for example, users who have had a common employer, have a common friend, or like a common film). Generally being connected in a social networking system allows connected users access to more information about each other than would otherwise be available to unconnected users. Likewise, becoming connected within a social networking system may allow a user greater access to communicate with another user, such as by email (internal and external to the social networking system), instant message, text message, phone, or any other communicative interface. Finally, being connected may allow a user access to view, comment on, download or endorse another user's uploaded content items. Examples of content items include but are not limited to messages, queued messages (e.g., email), text and SMS (short message service) messages, comment messages, messages sent using any other suitable messaging technique, an HTTP link, HTML files, images, videos, audio clips, documents, document edits, calendar entries or events, other user-generated content, and other computer-related files.

Online social networking systems may track objects through the use of a social graph, which includes a plurality of nodes that are interconnected by a plurality of edges. In the social graph, nodes represent objects within the context of the social networking system. Common examples of objects include users, content items, groups, web pages, fan pages, events, messages, concepts, interactions, information, activities, data, computer applications, advertisements or any other entity capable of being represented in a social networking system. Companies, locations, venues, merchants, bands, non-user persons, restaurants, or any other entities may be directly represented by a social networking system object, or may be indirectly represented by an object via a group, web page or fan page within the social networking system dedicated to the entity. For instance, the restaurant “Refuge” or the venue “Orpheum Theatre” may have dedicated objects within the social networking system; alternatively, Refuge may have a fan page and the Orpheum Theatre may have a web page on the social networking system.

An edge between nodes in the social graph represents a particular kind of connection between the two nodes, which may result from an interaction that occurred between the nodes. For instance, for two nodes that represent users, an edge may imply that the users are friends within the context of the social networking system. Alternatively, an edge may imply that the users have communicated with each other, that one user may have viewed the other's profile, that the users attended the same high school, or any other means of connection or interaction. For two nodes where at least one node does not represent a user, an edge may imply similar or different connections or interactions. For example, an edge may indicate a user clicked the “like” button for a group dedicated to a particular band, or that a user clicked on an advertisement. Alternatively, an edge may indicate that two companies, each represented by a social networking system web page, are associated with each other despite no explicit action by either company.

When a new object of a particular type is created, the social networking system may initialize a new node of the corresponding type, may assign a unique object or node identifier to it, and may begin to add data to the object as needed. This might occur, for example, when an individual first becomes a user of the social networking system, when the social networking system generates a new user profile, when a user starts a new group, when a new content item is uploaded to the social networking system, or any other time an object is added to or created within the social networking system. When a new object is created, an edge may be created linking the object node to the node representing the user who created the object. In addition, the social networking system may link the new object node or any existing nodes to other social graph nodes automatically. For instance, if a first user uploads a photograph of a sports bar to the social networking system, and afterwards, a fan page for the sports bar is created, the social networking system may provide an edge between the user node and the fan page node without explicit action by a user. Further, if a second user posts a comment about going to the sports bar on a third user's profile, the second user's and third user's nodes may be automatically connected to the sports bar node without explicit action by either user in regards to the sports bar node.

Users of social networking systems may interact with social networking system objects in a variety of forms, such as by communicating with or commenting on a content item, information or action; clicking a button or link associated with approval (such as a “like” button or the equivalent); sharing a content item, user information or user actions with other users; or downloading or merely viewing a content item. Interaction may also comprise using a computer-based application within the context of the social networking system (such as a video game only accessible and playable from within the social networking system), or an application external to the social networking system (such as a desk top web browser or mobile application) that may or may not interface with the social networking system. Further, interactions also include making a purchase, either in the context of the social networking system, or external to the social networking system; joining, commenting on or subscribing to a social networking system group, web page or fan page; using a mobile device to transmit a current or past location to the social networking system (“checking in” to a location); scheduling a meeting, gathering, errand, vacation, task, objective, reservation, date or any other event or calendar entry; and accepting an invitation to or indicating the intent to attend a meeting, gathering, party, concert, play or any other event. For instance, a user may join a group dedicated to Chopin, may buy tickets to a Chopin performance, may check into the concert hall when the user arrives at the performance, and may post a note to the user's profile reviewing the performance, all of which constitute interactions.

Users of social networking systems may also interact with other users by associating with, connecting to or becoming friends with them, by viewing their profile, by communicating with them, or by having common friends within the social networking system. In addition, a social networking system user may interact with content items, websites, other users or other information outside of the context of the social networking system's web pages that are connected to or associated with the social networking system. For instance, an article on a news web site might have a “like” button that users of the social networking system can click on to express approval of the article. Likewise, a company's website may provide the ability to join a social networking system group dedicated to the company directly from the company's website. These interactions and any other suitable actions within the context of a social networking system may be recorded in social networking system data, which can be used to generate social endorsement information. The social endorsement information may comprise text, images, links, and/or be of any suitable form necessary to convey social endorsement information to a user.

### Overview of Process

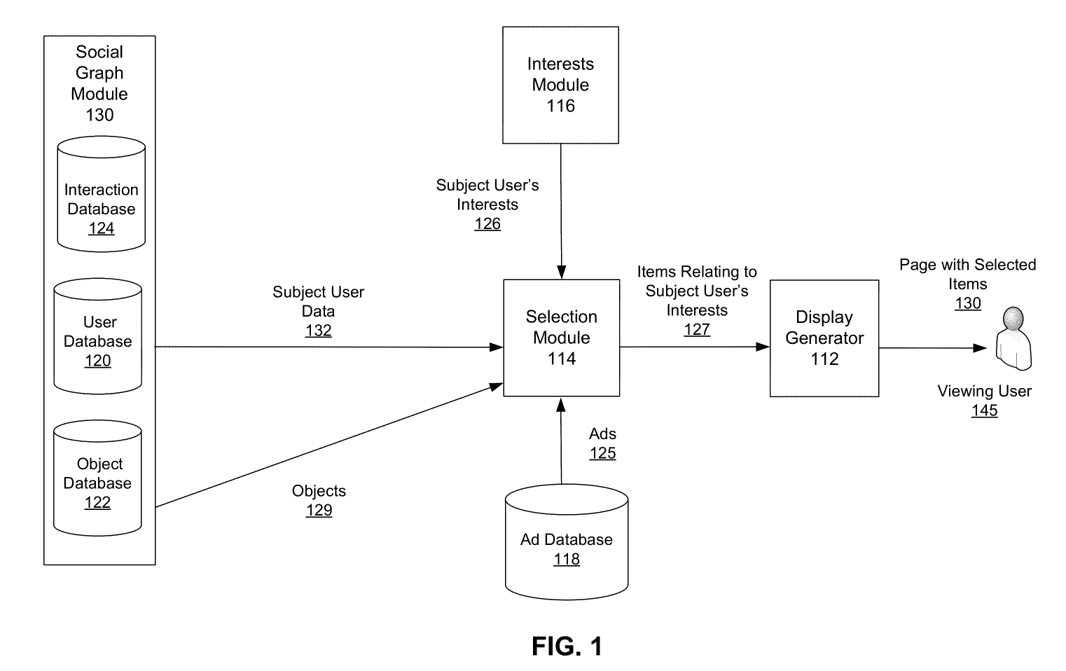

FIG. 1 is a diagram of a process for selecting information items to display to a viewing user based on a subject user's profile when the viewing user is viewing the subject user's profile page or other page that is associated with the subject user, in accordance with some embodiments. As illustrated, the social graph module 130 provides subject user data 132 to the selection module 114. The selection module 114 sends the subject user data 132 to the interests module 116 which determines a set of interests 126 for the subject user based on the subject user data 132. The interest module 116 sends the subject user's determined interests 126 to the selection module 114. As discussed in more detail herein, a user's interests may be expressed by the user (whether provided directly or indirectly, for example, through communications with other members) and/or impliedly based on the user's actions (e.g., a member's checking of another user's page indicates an interest in that other user, or clicking on particular types of links may indicate an interest in similar links). The ad database 118 provides the selection module 114 with a set of advertisements (“ads”) 125. The social graph module 130 provides objects 129 to the selection module 114. The selection module 114 selects one or more items from the set of ads 125 and/or the objects 129 matching the subject user's interests and sends the selected items 127 to the display generator 112. The display generator 112 inserts the selected items 127 into a page associated with the subject user and provides the page to the viewing user 145.

The social graph module 130 comprises an interaction database 124, a user database 120, and an object database 122. The user database 120 stores a social graph including a node for each user of the social networking system. Each node includes user information, user account information, profile information, user connections, and other user-related data. The profile information may include information such as biographic, demographic and other types of descriptive information (birthday, age, work experience, gender, educational history, hobbies or preferences, interests, geographic location, marital status, household size, political party and the like). For a respective user, the user database 120 stores a list of user identifiers corresponding to the nodes of the respective user's connections or friends in the social networking system. In some embodiments, the user database 120 stores a user's affinity for other users and objects in the social networking system.

The object database 122 stores any information relating to objects. This includes descriptive information visible to social networking system users, such as user profile, group profile, fan page profile information, message board contents, user-generated content (such as comments, uploaded photographs and videos, message, reviews, purchase information, search queries), event information, and any other information accessible to social networking system users. In addition, the object database 122 may store object data hidden to users, such as meta-tags, object keywords, category information, search indexes, and any other data accessible to the social networking system but not viewable to social networking system users.

The interaction database 124 stores data about user activities and interactions within the social networking system and outside of the social networking system. This includes specific interactions as discussed above, as well as activity levels and usage statistics. Whenever a user interacts with an object, an edge between the user node and the object node may be created in the social graph; this edge may be stored in the interaction database 124. The interaction database 124 includes information about a particular interaction and may include information about the user node and the target node associated with the interaction. The information may include a time stamp of when the action occurred, an identifier for the user who performed the action, a target identifier for the object or user that the action was directed, an action type, and an identifier for content associated with the action. Additionally, the interaction database 124 may store statistics for specific categories or types of actions. For example, for a given user the interaction database 124 may contain the number of wall posts in a 30 day period by a user, the number of photos posted by the user in a 30 day period, and the number of distinct users that received the user's comments in a 30 day period. For a given connection between two users, user A and user B, the interaction database 124 may contain information such as the number of profile page views from A to B, the number of photo page views from A to B, and the number of times A and B were tagged in the same photo, and these actions may be associated with a timestamp or may be filtered by a cutoff (e.g., 24 hours, 90 days, etc.).

The ad database 118 stores advertisements (“ads”). An ad includes a message inviting a user to perform an action, such as clicking on a link. In one embodiment, an ad is a web-based ad which is displayed in a dedicated area of a website. In another embodiment, an ad is displayed within a software application, video game, or a mobile device application. The ad database 118 may store a plurality of ad tags, which compromise information that may be coupled to an ad that may identify or otherwise describe the subject matter of the ad, the genre of the ad, the product or service represented by the ad, targeting criteria for the ad or any other characteristic, feature or property of the ad. The targeting criteria may include age, gender, income, geographic location, education, religion, race, marital status, household size, employment status, and political party affiliation.

An ad in the ad database 118 may be an advertisement, a poll, a news story, a suggested action, a media item provided to or maintained by the social networking system, a status message or link posted by a user to the social networking system, an event, a group, an action by a user, and a page associated with an entity in the social networking system. In some embodiments, the ad database 118 includes social ads or social endorsements. In some embodiments, a social ad is referred to as a sponsored story. A social ad comprises an advertising message that communicates a message about at least one user action from the interaction database 124. A social ad, for example, may inform a user that a friend (or a number of friends) of the user has purchased a particular item made by an advertiser, will attend an event sponsored by an advertiser, or has added a connection to a profile for a business or other entity. Other examples of actions that may be described in a social ad may include checking in at a location, purchasing a product or service, joining a group, attending an event, using a third party application, playing a game, or expressing an affinity towards an object in the social networking system. In some embodiments, a social ad communicates a message about the actions of some number of friends of a user. For example, a user may receive a message like “Three of your friends have joined the “Yale Alumni Network.” The advertising message may also include additional content from the advertiser. The advertising message is communicated to the friend, for example as a message on the friend's home page, in an email message, in a list or newsfeed of other advertising messages and stories describing various actions taken, or any other electronic communication medium. In some embodiments, a social ad includes an indication that a friend of the viewing user approves of a product or service associated with the ad or has otherwise interacted with an object associated therewith. For example, a social ad may include a testimonial from a friend or an indication that the friend is a fan of a product.

These embodiments describing providing advertisements targeted to a subject user are merely meant to be exemplary and are not intended to be restrictive. In other embodiments, there are more or fewer components performing the same or substantially similar functions as the components of the embodiment of FIG. 1. For instance, the user database 120, the object database 122, and the interaction database 124 may all comprise the same storage entity. In addition, as will be discussed below, in some embodiments, the functionality of the interests module 116, selection module 114 and display generator 112 module may be provided by the social networking system; in other embodiments, all or part of this functionality may be provided external to the social networking system.

### System Overview

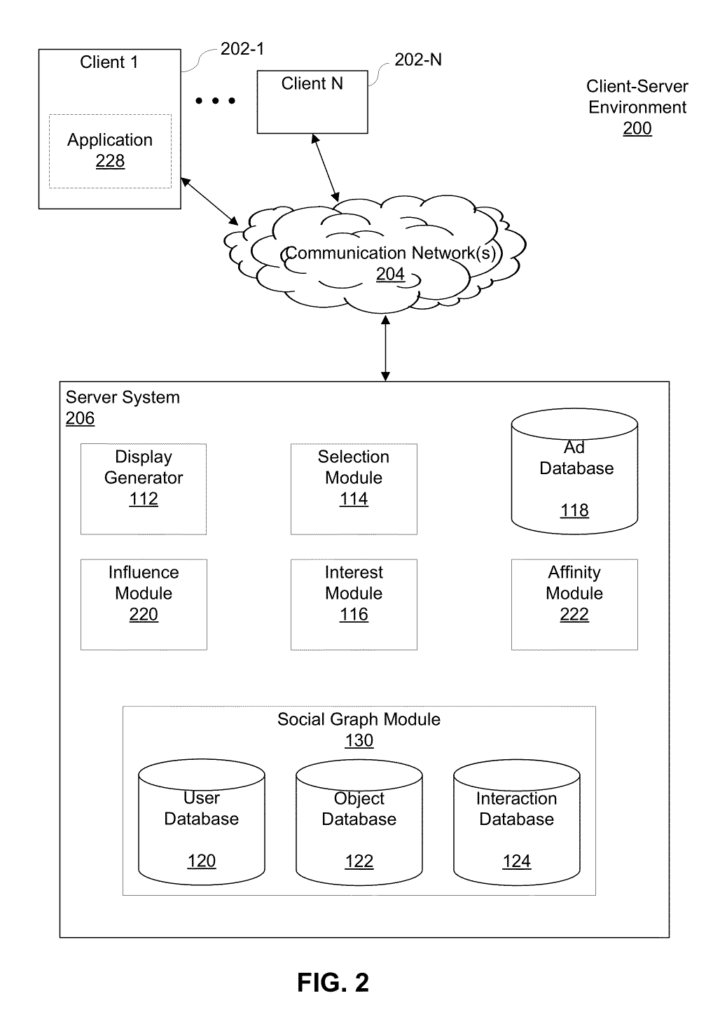

FIG. 2 is a high level block diagram of a distributed system 200 of a social networking system according to one embodiment of the invention. The system 200 includes one or more clients 202 and a server system 206 connected by a network 204.

In some embodiments, the server system 206 is implemented as a single server, while in other embodiments it is implemented as a distributed system of multiple servers. For convenience of explanation, server system 206 is described below as being implemented on a single server system.

The communication network(s) 204 can be any wired or wireless local area network (LAN) and/or wide area network (WAN), such as an intranet, an extranet, or the Internet. It is sufficient that the communication network 204 provides communication capability between the client devices 202 and the server system 206. In some embodiments, the communication network 204 uses the HyperText Transport Protocol (HTTP) and the Transmission Control Protocol/Internet Protocol (TCP/IP) to transmit information between devices or systems. HTTP permits client device 202 to access various resources available via the communication network 204. The various embodiments of the invention, however, are not limited to the use of any particular protocol.

A user interacts with the server system 206 using a client device 202, which may be any suitable computer device that is capable of connecting to the server system 206 via communication network 204, such as a computer, a desktop computer, a laptop computer, a tablet device, a netbook, an internet kiosk, a personal digital assistants, a mobile phone and a gaming device. The client device 202 may communicate with the server system 206 via an application 228 such as a web browser or native application. Typical interactions between the client device 202 and the server system 206 include operations such as viewing profiles of other users of the server system 206, sending messages to other users, contributing and interacting with media items, joining groups, listing and confirming attendance at events, checking in at locations, liking certain pages, creating pages, and performing other tasks that facilitate social interaction.

The selection module 114 selects information items and/or advertising items to display to a viewing user when the viewing user views a page associated with a subject user. As discussed in more detail herein, the selection module 114 receives a viewing user's request for a page associated with a subject user, determines a set of users to target, determines using the interests module 116 sets of interests for the targeted users, and selects advertising items based on the determined sets of interests.

The selection module 114 receives a viewing user's request for a page associated with a subject user responsive to the viewing user requesting a page associated with the subject user. The requested page may be a profile page of the subject user, a profile page of a connection of the subject user, a photo album in which the subject user appears, a gaming page containing information about the subject user's gaming activity, or a messaging page containing a message by the subject user.

When a viewing user requests a page associated with a subject user, the selection module 114 may request that the interest module 116 determine the interests for the viewing user, the subject user, mutual connections of the viewing user and the subject user, connections of the viewing user that the viewing user has recently interacted with, subject users of pages recently viewed by the viewing user, or any combination thereof. A viewing user is a viewer or requestor of a page. A page shows information corresponding to one or more subject users. For example, as discussed above, a message page may contain messages by a subject user.

In some embodiments, the selection module 114 determines who to determine interests for based on the relationship or connection status between the subject user and the viewing user. The two users may be connected to each other or friends if a first user requests to be connected to a second user and the second user accepts. In some embodiments, when the subject user and viewing user are connected, the selection module 114 sends a request to the interests module 116 to determine interests for the subject user and optionally for the viewing user. In some embodiments, when the subject user and the viewing user are not friends, the selection module 114 sends a request to the interests module 116 to determine interests for the mutual connections of the viewing user and the subject user. As discussed in more detail herein, the interests module 116 may select a subset of the mutual connects to determine interests for based on the viewing user's affinity for the mutual friends, the subject user's affinity for the mutual friends, or the number of common interests between the mutual friends and the viewing user and/or subject user. In some embodiments, when a viewing user views a page associated with himself/herself, the selection module 114 sends a request to the interests module 116 to determine interests for users that the viewing user has recently interacted with or users associated with pages that the viewing user has recently viewed.

In some embodiments, the selection module 114 selects advertising items based on the set of interests determined by the interests module 116. The selected items are related to or target a determined interest. For example, an item containing information about a subject user's check in at a baseball game may be selected based on the subject user's interests in baseball. The selection module 114 retrieves a set of items from the ad database 118 and/or object database 112 that have tags that relate to the determined interests. The selection module 114 selects items from the retrieved set of items that would be most relevant to the viewing user's interests.

In some embodiments, the selection module 114 determines selection factors to help determine which advertising items are selected. As discussed in more detail herein, the selections factors may include interest affinities, user affinities, areas of user influences, or any combination thereof. The selection module 114 may use the additional selection factors to determine which interests to give priority in the selection process. The specific interests, interests of the subject user, the viewing user or the mutual interests of the subject user and viewing user may be prioritized. For example, mutual interests between two user may be given highest priority followed by interests of a specific user. Specific interests may be prioritized, for example, the interest of sports may be prioritized. In some embodiments, the selection module 114 retrieves a set of advertising items that relate to the determined interests and assigns weights to advertising items based on the priority assigned to the interest. For example, if a priority for a subject user's interest in baseball is greater than the subject user's in tennis, the advertising items relating to baseball will be given a greater weight than the items relating to tennis. The selection module 114 may also use the additional selection factors to determine the mix of advertising items selected. For example, the selection module 114 may determine that a predetermined number or all of the advertising items should be targeted to the interests of the subject user or the mutual interests of two users.

In some embodiments, the selection module 114 may prioritize interests based on interest affinities assigned to each determined interests. As discussed in more detail herein, the interests module 116 may determine a set of interests for a user and interests affinities for each determined interest.

In some embodiments, the selection module 114 may request that the affinity module 222 determine affinities between the viewing user, the subject user, and mutual connections of the viewing user and the subject user. The selection module 114 uses user affinities as a selection factor to prioritize or select a set of interests that will be used to select a set of advertising items. The selection module 114 may use the viewing user's affinity towards the subject user and/or the subject user's affinity towards the viewing user. In some embodiments, when the viewing user's affinity towards the subject user is above a threshold score, the selection module 114 may determine that the interests of the subject user should given higher priority or that a number of the advertising items should be targeted to the subject user's interests. Thus, when the viewing user has a sufficient affinity for the subject user, there is a higher likelihood that the subject user's interests are relevant to the viewing user. On the other hand, if the viewing user has an affinity for the subject user below a threshold score, the selection module 114 may determine that the viewing user's interests should be given higher priority or that a number of the advertising items should be targeted towards the viewing user's interests. Thus, when the viewing user has insufficient interest in the subject user, advertising items targeted towards the viewing user may be more relevant to the viewing user's interests. In some embodiments, the mutual interests of the viewing user and the subject user may be prioritized when the viewing user's affinity for the subject user is above a threshold score.

In some embodiments, the selection module 114 uses both the viewing user's affinity score towards the subject user and the subject user's affinity score towards the viewing user to determine which advertising items to select. When the viewing user and the subject user's affinity for each other is below a threshold score, the selection module 114 may select the advertising items based at least in part on the interests of the mutual connections of the subject user and the viewing user or the mutual interests of the subject user and the viewing user.

In some embodiments, the selection module 114 may request that the influence module 220 determine the areas of interest or domains of information that a user influences another user. The selection module 114 may request that the influence module 220 determine which areas of interests that a subject user or mutual friend (of the subject user and viewing user) influences a viewing user. For example, the subject user may influence a viewing user in the domain of travel. The selection module 114 may receive a set of weighted interests from the influence module 220. The weight applied to each interest measures the influence that a subject user or mutual friend has on a viewing user in a particular domain. In some embodiments, the selection module 114 prioritizes the interests that have an influence above a certain threshold in the item selection process. For example, if the subject user sufficiently influences the viewing in the areas of travel and sports, the selection module 114 gives greater weight to advertising items targeting travel and/or sports.

The selection module 114 selects one or more advertising items based on the various criteria discussed above and sends the selected items to the display generator 112. The items may be selected from the ad database 118 and/or the social graph 130. The selection module 114 may use tags associated with the items to identify items that match or relate to the set of interests.

The interests module 116 receives a set of user identifiers from the selection module 114 and determines interests for the users corresponding to the user identifiers. A user may have interests in other users, places, things, activities, content, advertisements, or any other object in the social networking system.

The interests module 116 may determine a user's interests based on any information associated with the user stored in the user database 120, object database 122, and the interaction database 124. In some embodiments, the interests module 116 determines weights or interests affinity scores for each of a user's determined interests. The affinity scores measure the user's affinity for the determined interests. For example, a user's interests in coffee (e.g., 0.9) may be greater than the user's interests in donuts (e.g., 0.8). The interests for a user may be derived or extracted from actions of the users, posted content from the user, profile information for user, or any combination thereof. A user's interests may be specified by the user. For example, the user may have specified their favorite books, people, television shows, hobbies, and activities. A user's interests may be determined based on the user's actions including commenting on a content item, using a third party application, playing a game, inviting a connection to perform an activity, joining a group, posting a status message, or expressing an affinity for an object in the social networking system. For example, a user may select a “like” button associated with another user's content item or status update to indicate that the user has an interest in something in the content item or status update. In another example, a user may join a group about restaurants in San Francisco and the interests module 116 may determine that the user is interested in food, restaurants, and San Francisco. A user's interests may be determined based on actions that take place within the social networking system or outside of it. For example, whenever a user purchase a product on a third party website, the third party website may send transaction information to the social networking system.

In some embodiments, interests determined from a user's actions are decayed over time based on a decay factor. The decay factor may be based on the type of action that the interest was derived from. For example, joining a group associated with an object might indicate a higher affinity than merely “liking” the same object. Similarly, “leaving” a page might indicate a low interest factor. Some embodiments employ the approach of accounting for the actions in specific windows of time, and discounting or weighting the windows of time differently. For example, actions in the last 30 days may be associated with a discount factor of 0.5 while actions in the last 90 days may be associated with a discount factor of 0.25.

The affinity module 222 determines the affinity between users. More specifically, the affinity module 222 receives requests with user identifiers, determines affinities between the users corresponding to the identifiers, and returns the determined affinities. For a viewing user and a subject user, the affinity module 222 may determine the viewing user's affinity for the subject user, the subject user's affinity for the viewing user, or a single affinity between the subject user and viewing user. The affinity module 222 uses user data from the social graph 130 to determine affinities. The affinity module 222 may generate affinity scores for two users based on the frequency of interactions between the two users, types of interactions between the two users, number of interactions between the two users, or any combination thereof. In one example, a first user's affinity for a second user may be determined based on the number of times the first user viewed the second user's profile.

The influence module 220 determines the areas of interests or domains of information in which a user influences another user. For example, the influence module 220 may determine that a user influences another user in the area of football. The influence module 220 may also measure the influence a user has on another user in a particular area of interests or domain of information. Using the previous example, the influence module 220 may measure the influence of a subject user on a viewing user in the area of football. The influence module 220 uses interaction data from the social graph 130 to determine a subject user's influence in a particular domain of information or interest area. For example, the influence module 220 may use click-through rates of social ads or other suggestions and content items that are related to the subject user and the domain of information. If a viewing user has a click-through rate above a certain threshold on social ads that describe activities of the subject user relating to football, the influence module 220 may determine that the subject user influences the viewing user in the area of football. In this case, the influence module 220 may measure the subject user's influence over the viewing user in the area of football based on the viewing user's click-through rate of items relating to the subject user and football.

The display generator 112 receives the selected advertising items and sends the selected advertisings items to a user for display. In some embodiments, the display generator generates a page, inserts the selected advertising items into the page, and sends the page to a user for display. The display generator 112 module retrieves user data from the social graph 130 to generate a page associated with a user. For example, the display generator 112 may generate a profile page of a user. In some embodiments, the display generator 112 sends the selected advertising items or page containing the selected advertising items to a native application or a third party website.

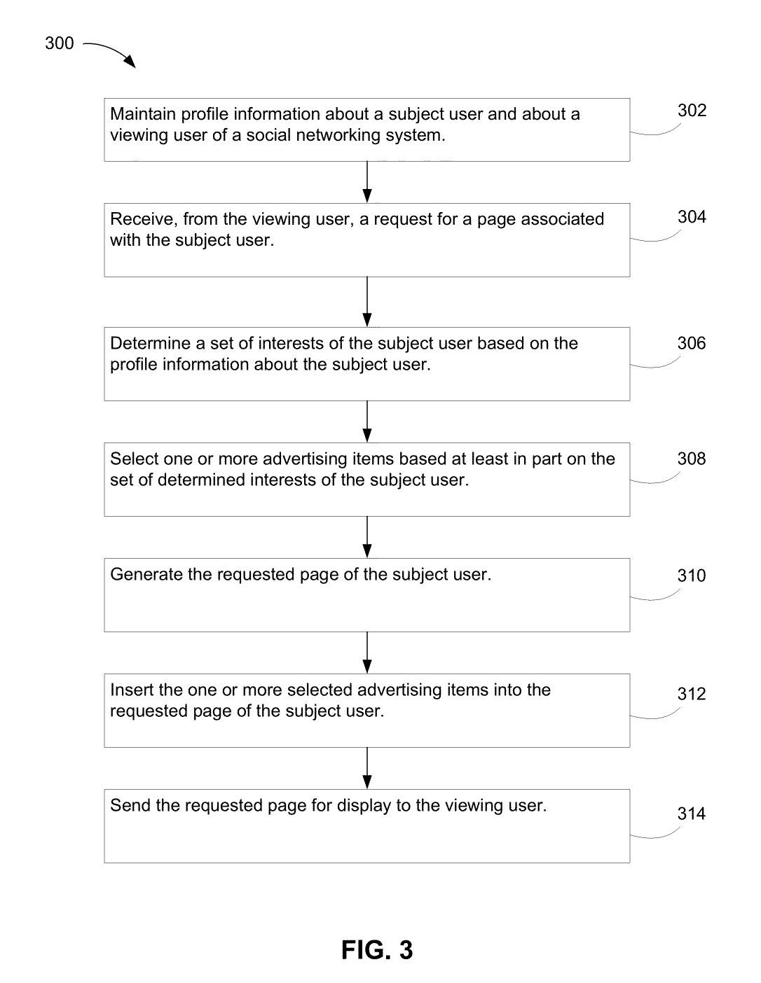

FIG. 3 is a flow chart of a process 300 for providing advertising items to a viewing user based on information about a subject user when the viewing user is viewing a page of information related to the subject user, in accordance with some embodiments. Process 300 is performed at a server system (e.g., server system 206) having one or more processors and non-transitory memory. The non-transitory memory stores one or more programs to be executed by the one or more processors. The one or more programs include instructions for process 300.

In process 300, profile information about a subject user and about a viewing user of a social networking system is maintained 302. The profile information about the subject user and about the viewing user is maintained in the social graph module 130. A request for a page associated with a subject user is received 304 from the viewing user. The requested page may be a profile page of the subject user, a profile page of a connection of the subject user, a photo album in which the subject user appears, a gaming page containing information about the subject user's gaming activity, or a messaging page containing a message by the subject user. In some embodiments, the selection module 114 receives the request in response to an action by a viewing user. For example, the viewing user may click on a picture or link associated with the subject user.

The interests module 116 determines 306 a set of interests of the subject user based on the profile information about the subject user. As discussed above, when a user views a page associated with a subject user, the subject user's interests become a proxy for the viewing user's interests. In some embodiments, the one or more interests for the subject user are determined at least in part on actions of the subject user. The actions may include commenting on a content item, using a third party application, playing a game, inviting a connection to perform an activity, joining a group, posting a status message, or expressing an affinity for an object in the social networking system. The interests may be decayed in accordance with a decay factor. In some embodiments, the decay factor is determined based a time of action from which an interest was determined and/or the type of action performed.

In some embodiments, a set of interests of the viewing user is determined based on the profile information about the viewing user. In some embodiments, the set of interests for the viewing user is determined based at least in part on actions of the viewing user. In this case, the determined set of interests is discounted based at least in part on a decay factor. In some embodiments, the decay factor is determined based a time of action from which an interest was determined and/or the type of action performed.

One or more advertising items are selected 308 by the selection module 114 based at least in part on the set of determined interests of the subject user. In some embodiments, a set of interests of the viewing user is determined based on the profile information about the viewing user and the one or more information items are selected based at least in part on the determined interests of the viewing user. Thus, in some embodiments, the selection module 114 may select the one or more advertising items based on the interests of both the viewing user and the subject user. In some embodiments, the one or more advertising items are selected based on the mutual interests of the viewing user and the subject user.

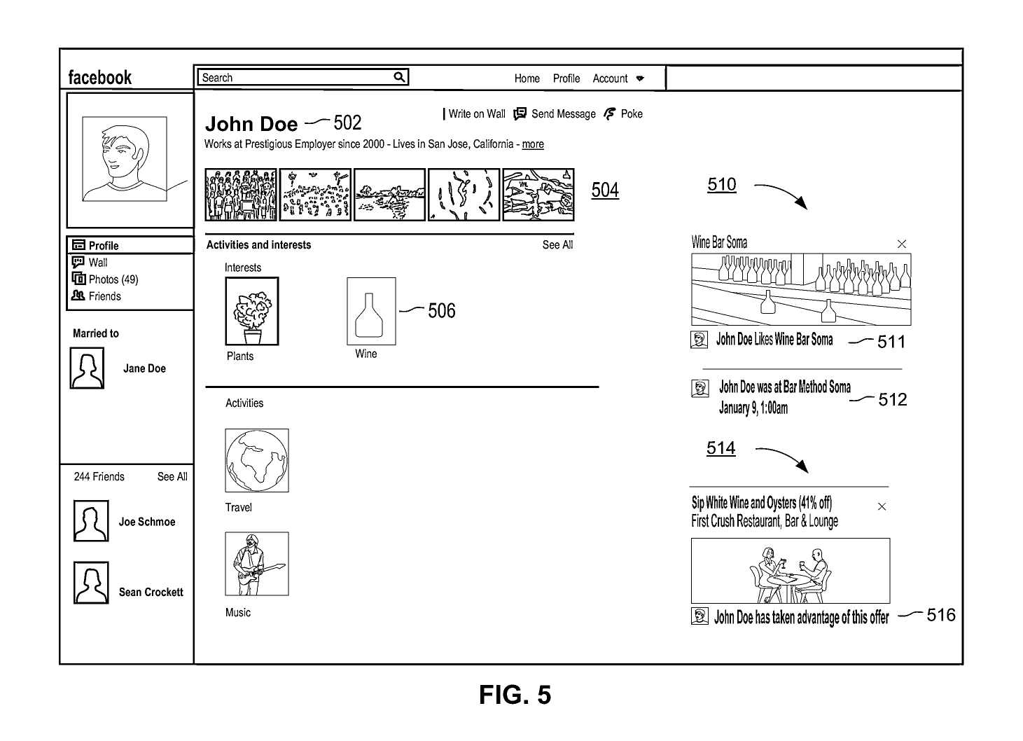

In some embodiments, at least one advertising item is selected based on existence of endorsement information for the subject user and the advertising item includes the endorsement information. The endorsement information includes information about an action taken by the subject user. As discussed above, an advertisement with endorsement information for a user is also called a social ad. Thus, in some embodiments, the selection module 114 selects social ads that contain information about actions of the subject user or another user. In some embodiments, at least one of the selected advertising items includes an indication that the subject user checked in at a location relating to a determined interest of a user. For example, as shown in FIG. 5, a recent check in 512 at a wine bar by the subject user may be retrieved or generated as an social ad to display to a viewing user. In some embodiments, at least one of the selected information items includes an indication that the subject user has expressed an interest in a determined interest. For example, the subject user may have posted a content item relating to wine, posted a positive message about a certain vintage of wine, or joined a group relating to wine. For example, as shown in FIG. 5, the social ad 510 includes an indication 511 that that user John Doe likes a particular wine bar. In some embodiments, at least one of the information items includes an indication that the subject user purchased a product or service associated with a determined interest. For example, as shown in FIG. 5, the social ad 514 includes an indication 516 that user John Doe took advantage of an offer related to the ad social 514.

In some embodiments, the one or more advertising items are selected based on the viewing user's affinity for the subject user. In some embodiments, when the viewing user's affinity towards the subject is above a threshold score, a number of the selected advertising items are targeted to the subject user's interests or the mutual interests of the viewing user and the subject user. In this case, the interests of subject user may be given higher weights than the interests of the viewing user. Thus, when the viewing user has a sufficient affinity towards the subject user, there is a higher likelihood that the subject user's interests are relevant to the viewing user. When the viewing user has an affinity for the subject user below a threshold score, the majority of the selected advertising items are targeted to the viewing user's interests. Thus, when the viewing user has insufficient interest in the subject user, advertising items targeted towards the viewing user may be more relevant to the viewing user's mindset.

In some embodiments, domains of information in which the subject user has influence over the viewing user are determined. A domain of information may be an interest of a user. In some embodiments, a domain of information is a mutual interest of the subject user and the viewing user. For example, the subject user may influence the viewing user in the domain of sports. In some embodiments, the one or more advertising items are selected based at least in part on the one or more determined domains of information. Using the previous example, if the subject user influences the viewing user in the area of sports, the viewing user may be more likely to pay attention to advertising items relating to sports when viewing a page associated with the subject user. Domains of information in which the subject user has influence may be given higher priority than other interests of the subject user or the viewing user. In some embodiments, at least a portion of the selected advertising items relate to the domains of information in which the subject user has influence.

In some embodiments, the selection module 114 selects a group of advertising items. The advertising items in the group have an element such as being related to a common interest or describing the same type of action. For example, the items in the group may be related to restaurants or each item may be a check in at a restaurant. In some embodiments, a search box is associated with the group of information items. When displayed concurrently with the group of items, a user can use the search box to search for items in the group. In some embodiments, the search box allows a user to search for information items that belong to the group but are not displayed.

The one or more advertising items include an invitation for the viewing user to perform an action. The action may be any action discussed above. For example, the invitation may ask a user to play a game or to select a link.

The requested page for the subject user is generated 310, where the requested page comprises the profile information about the subject user. The display generator 112 inserts 312 the selected advertising items into the requested page of the subject user. The display generator sends 314 the requested page to the viewing user for display.

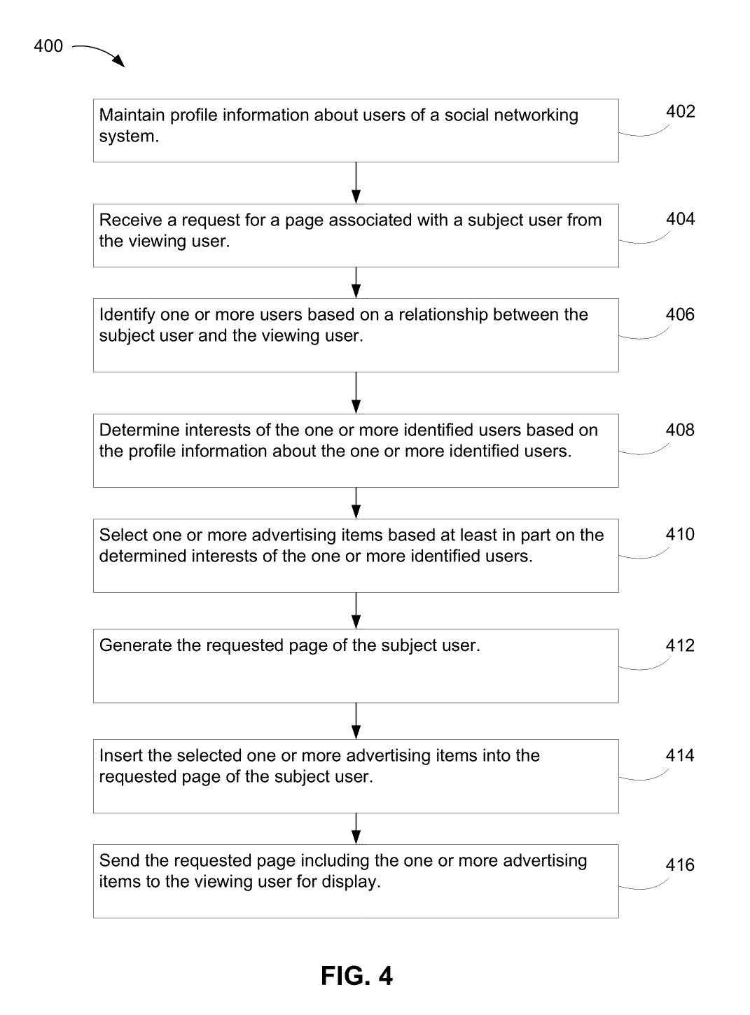

FIG. 4 is a flow chart of a process 400 for providing advertising items based on the relationship between a viewing user and a subject user, in accordance with some embodiments. Process 400 is performed at a server system (e.g., server system 206) having one or more processors and non-transitory memory. The non-transitory memory stores one or more programs to be executed by the one or more processors. The one or more programs include instructions for process 400.

Profile information about users of a social networking system is maintained 402. A request for a page of a subject user is received 404 from a viewing user. The requested page may be a profile page of the subject user, a profile page of a connection of the subject user, a photo album in which the subject user appears, a gaming page containing information about the subject user's gaming activity, or a messaging page containing a message by the subject user. One or more users are identified 406 based on a relationship between the subject user and the viewing user in the social networking system. The relationship describes the users as being friends or not friends. Two users are friends if they have established a connection in the social networking system with each other. The one or more identified users may be the subject user, the viewing user, mutual connections of the subject user and the viewing user, users that the viewing user has recently interacted with, users associated with pages that the viewing user has recently viewed, or any combination thereof. The relationship between the users is determined by the selection module 114.

Interests of the one or more identified users are determined 408 by the interests module 116 based on the profile information about the one or more identified users. One or more advertising items are selected 410 based at least in part on the determined interests of the one or more identified users. In some embodiments, the subject user and the viewing user are friends, the interests are determined for the subject user, and the one or more advertising items are selected based on the determined interests of the subject user. In some embodiments, when the subject user and the viewing user are friends, interests are determined for both the subject user and the viewing user, and the one or more advertising items are selected based on the mutual interests of the subject user and the viewer user.

In some embodiments, the subject user and the viewing user are non-friends, the one or more identified users are mutual friends of the subject user and the viewing user, and the one or more advertising items are selected based on interests of the mutual friends. In this case, when a viewing user views a profile page of a non-friend, advertising items relating to the interests of one or more mutual friends are selected. The mutual friends may be selected based on the viewing user's affinity for the mutual friends or the subject user's affinity for the mutual friends. In some embodiments, the mutual friend having the highest number of common interests with the subject user is selected.

In some embodiments, the subject user and viewing user are non-friends, the interests are determined for the subject user, and the one or more information items are selected based on matching interests of the viewing user and the subject user. The viewing user's interests are matched to the subject user's publicly accessible interests. The portion of the subject user's information that is publicly available is determined by the subject user's privacy control settings.

The requested page of the subject is generated 412 where the page comprises the profile information about the subject user. The display generator 112 inserts 414 the one or more information items into the profile page of the subject user. The profile page including the one or more information items is sent 416 to the viewing user for display.

In some embodiments, a request is received from the viewing user for a page associated with the viewing user. For example, the viewing user has requested to view the viewing user's own profile page. In this case, interests of one or more friends of the viewing user that the viewing user has recently interacted with may be determined and/or interests of users associated with pages that the viewing user has recently viewed may be determined. One or more advertising items are selected based at least in part on the determined interests of the one or more friends of the viewing user as discussed above.

The requested page of the viewing user is generated 412 where the profile page comprises profile information about the viewing user. The selected one or more advertising items are inserted 414 into the requested page of the viewing user. The requested page including the one or more information items is sent 416 to the viewing user for display.

### SUMMARY

The foregoing description of the embodiments of the invention has been presented for the purpose of illustration; it is not intended to be exhaustive or to limit the systems and methods to the precise forms disclosed. Persons skilled in the relevant art can appreciate that many modifications and variations are possible in light of the above disclosure.

Some portions of this description describe the embodiments of the systems and methods in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the systems and methods may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the systems and methods may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the systems and methods systems and methods be limited not by this detailed description, but rather by any claims that issue on an application based hereon. Accordingly, the disclosure of the embodiments of the systems and methods are intended to be illustrative, but not limiting, of the scope of the invention, which is set forth in the following claims.

What is claimed is:

1. A computer-implemented method comprising:
maintaining profile information about a subject user and about a viewing user of a social networking system;
receiving, from the viewing user, a request for a profile page of the subject user;
determining a set of interests of the subject user based on the profile information about the subject user;
selecting one or more advertising items based at least in part on the set of determined interests of the subject user;
generating the profile page of the subject user based on the profile information about the subject user;
inserting the selected one or more advertising items into the profile page of the subject user; and
sending the profile page including the one or more information items for display to the viewing user.

2. The method of claim 1, wherein the one or more advertising items includes an invitation for the viewing user to perform an action.

3. The method of claim 1, wherein at least one of the selected advertising items is selected is selected based on existence of endorsement information for the subject user, and wherein the advertising item includes the endorsement information.

4. The method of claim 3, wherein at least one of the selected advertising items includes an indication that the subject user checked in at a location associated with a determined interest.

5. The method of claim 3, wherein at least one of the selected advertising items includes an indication that the subject user expressed an interest in a determined interest.

6. The method of claim 3, wherein at least one of the selected advertising items includes an indication that the subject user purchased a product or service associated with an advertising item.

7. The method of claim 1, further comprising determining a set of interests of the viewing user based on the profile information about the viewing user, and wherein the one or more advertising items are further selected based at least in part on the set of determined interests of the viewing user.

8. The method of claim 6, wherein the one or more advertising items are selected based on mutual interests of the viewing user and the subject user.

9. The method of claim 1, wherein the one or more interests for the subject user are determined based at least in part on actions of the subject user and wherein the set of determined interests for the subject user are discounted based on a decay factor.

10. The method of claim 6, wherein the set of interests for the viewing user are determined based at least in part on actions of the viewing user and wherein the set of determined interests are discounted based on a decay factor.

11. The method of claim 1, wherein the one or more advertising items are selected based on the set of determined interests of the subject user when the viewing user's affinity for the subject user is above a threshold.

12. The method of claim 1, further comprising determining one or more domains of information in which the subject user has influence over the viewing user, and wherein the one or more advertising items are further selected based at least in part on the one or more determined domains.

13. A non-transitory computer readable storage medium storing one or more programs configured to be executed by a server system, the one or more programs comprising instructions for:
maintaining profile information about a subject user and about a viewing user of a social networking system;
receiving, from the viewing user, a request for a profile page of the subject user;
generating the profile page of the subject user, the profile page comprising the profile information about the subject user;
determining a set of interests of the subject user based on the profile information about the subject user;
selecting one or more advertising items based at least in part on the set of determined interests of the subject user;
inserting the selected one or more information items into the profile page of the subject user; and
sending the profile page including the one or more advertising items for display to the viewing user.

14. A computer-implemented method comprising:
maintaining profile information about a subject user and about a viewing user of a social networking system;
receiving, from the viewing user, a request for a page associated with the subject user;
determining a set of interests of the subject user based on the profile information about the subject user;
selecting one or more advertising items based at least in part on the set of determined interests of the subject user;
generating the requested page of the subject user based on the profile information about the subject user;
inserting the selected one or more advertising items into the requested page of the subject user; and
sending the requested page including the one or more advertising items for display to the viewing user.

15. The method of claim 13, wherein the requested page is selected from the group consisting of a profile page of the subject user, a profile page of a connection of the subject user, a photo album in which the subject user appears, a gaming page containing information about the subject user's gaming activity, and a messaging page containing a message by the subject user.

16. A computer-implemented method, comprising:
maintaining profile information about users of a social networking system;
receiving, from a viewing user, a request for a page associated with a subject user;
identifying one or more users based on a relationship between the subject user and the viewing user in the social networking system;
determining interests of the one or more identified users based on the profile information about the one or more identified users;
selecting one or more advertising items based at least in part on the determined interests of the one or more identified users;
generating the requested page of the subject user, the requested page comprising the profile information about the subject user;
inserting the selected one or more advertising items into the requested page of the subject user; and
sending the requested page including the one or more advertising items to the viewing user.

17. The method of claim 15, wherein the requested page is selected from the group consisting of a profile page of the subject user, a profile page of a connection of the subject user, a photo album in which the subject user appears, a gaming page containing information about the subject user's gaming activity, and a messaging page containing a message by the subject user.

18. The method of claim 13, wherein the relationship is selected from the group consisting of friends or non-friends.

19. The method of claim 14, wherein the subject user and the viewing user are friends, the interests are determined for the subject user and the one or more advertising items are selected based on the determined interests of the subject user.

20. The method of claim 14, wherein the subject user and the viewing user are non-friends, the one or more identified users are mutual friends of the subject user and the viewing user and the one or more advertising items are selected based on interests of the mutual friends.

21. The method of claim 14, wherein the subject user and the viewing user are non-friends, the interests are determined for the subject user and the viewing user and the one or more advertising items are selected based on matching interests of the viewing user and the subject user.

22. The method of claim 13, further comprising:
receiving a request from the viewing user for a page of the viewing user;
determining interests for one or more friends of the viewing user that the viewing user has recently interacted with;
selecting one or more advertising items based at least in part on the determined interests of the one or more friends;
generating the requested page of the viewing user, the requested page comprising the profile information about the subject user;
inserting the selected one or more advertising items into the requested page of the subject user; and
sending the requested page including the one or more advertising items to the viewing user.
